(19) United States
(12) Patent Application Publication
(10) Pub. No.: US 2021/0089497 A1
(43) Pub. Date: Mar. 25, 2021

(54) METHOD, DEVICE, AND COMPUTER PROGRAM PRODUCT FOR MANAGING DATA OBJECT

(71) Applicant: EMC IP Holding Company LLC, Hopkinton, MA (US)

(72) Inventors: Yizhou Zhou, Chengdu (CN); Yuting Zhang, Chengdu (CN)

(21) Appl. No.: 16/699,580

(22) Filed: Nov. 30, 2019

(30) Foreign Application Priority Data
Sep. 25, 2019 (CN) 201910911231.0

(51) Int. Cl. G06F 16/11; G06F 16/16; G06F 16/182; G06F 16/14; G06F 16/17; G06F 21/62; H04L 9/06

(52) U.S. Cl. CPC G06F 16/119; G06F 16/164; G06F 16/182; H04L 9/0637; G06F 16/1734; G06F 21/6218; G06F 16/152

(57) ABSTRACT

This disclosure relates to a method, a device, and a computer program product for managing a data object. In a method, a migration request for migrating a data object from the source application system to the destination application system is received. The migration request is validated based on a set of migration records in the data flow blockchain comprising a migration history of the data object being migrated between a plurality of application systems. A migration record associated with the migration request is added into the data flow blockchain in response to the validation of the migration request. The data object is migrated from the source application system to the destination application system.

### CROSS-REFERENCE TO RELATED APPLICATIONS

This application claims benefit to Chinese Patent Application 201910911231.0 filed on Sep. 25, 2019. Chinese Patent Application 201910911231.0 is hereby incorporated by reference in its entirety.

### TECHNICAL FIELD

Various implementations of this disclosure relate to application systems, and in particular, to a method, a device, and a computer program product for managing migration of a data object between a plurality of application systems in an application environment.

### BACKGROUND

With the development of data storage technologies, a variety of technologies for improving the level of data protection in an application system have emerged already. A data object originally stored in one application system may be migrated to another application system for data use, data security, storage system expansion, or other reasons. Therefore, how to manage the migration of a data object more reliably and effectively has become a research hotspot.

### SUMMARY OF THE INVENTION

According to a first aspect of this disclosure, a method for managing a data object in an application environment is provided. The application environment comprises a source application system, a destination application system, and a data flow blockchain. In the method, a migration request for migrating the data object from the source application system to the destination application system is received. The migration request is validated based on a set of migration records in the data flow blockchain comprising a migration history of the data object being migrated between a plurality of application systems in the application environment. A migration record associated with the migration request is added into the data flow blockchain in response to the validation of the migration request. The data object is migrated from the source application system to the destination application system.

According to a second aspect of this disclosure, a device for managing a data object in an application environment is provided, the application environment comprising a source application system, a destination application system, and a data flow blockchain, and the device comprising: at least one processing unit; and at least one memory coupled to the at least one processing unit and storing instructions for execution by the at least one processing unit, wherein when executed by the at least one processing unit, the instructions cause the apparatus to perform actions. The actions comprise: receiving a migration request for migrating the data object from the source application system to the destination application system; validating the migration request based on a set of migration records in the data flow blockchain comprising a migration history of the data object being migrated between a plurality of application systems in the application environment; adding a migration record associated with the migration request into the data flow blockchain in response to the validation of the migration request; and migrating the data object from the source application system to the destination application system.

According to a third aspect of this disclosure, a computer program product is provided. The computer program product is tangibly stored in a non-transitory computer readable medium and comprises machine executable instructions for performing the method according to the first aspect of this disclosure.

### BRIEF DESCRIPTION OF THE DRAWINGS

The features, advantages, and other aspects of this disclosure will become more apparent with reference to accompanying drawings and the following detailed description. Several implementations of this disclosure are illustrated here in an exemplary rather than restrictive manner. In the accompanying drawings:

FIG. 1 schematically illustrates a block diagram of a process for managing a data object according to a technical solution;

FIG. 2 schematically illustrates a block diagram of a process for managing a data object according to an exemplary implementation of this disclosure;

FIG. 3 schematically illustrates a flowchart of a method for managing a data object according to an exemplary implementation of this disclosure;

FIG. 4 schematically illustrates a structural block diagram of a data flow blockchain according to an exemplary implementation of this disclosure;

FIG. 5 schematically illustrates a block diagram of a migration record according to an exemplary implementation of this disclosure;

FIG. 6 schematically illustrates a block diagram of a data flow blockchain and a metadata blockchain according to an exemplary implementation of this disclosure;

FIG. 7 schematically illustrates a block diagram of a process for migrating a data object from a source application system to a destination application system according to an exemplary implementation of this disclosure;

FIG. 8 schematically illustrates a block diagram of a process for migrating a data object from a source application system to a destination application system according to an exemplary implementation of this disclosure; and

FIG. 9 schematically illustrates a block diagram of a device for migrating a data object according to an exemplary implementation of this disclosure.

### DETAILED DESCRIPTION

Preferred implementations of this disclosure will be described in more detail below with reference to the accompanying drawings. The preferred implementations of this disclosure have been shown in the accompanying drawings. However, it should be understood that this disclosure can be implemented in various forms and should not be limited by the implementations described here. In contrast, the implementations are provided to make this disclosure more thorough and complete, and the scope of this disclosure can be fully conveyed to those skilled in the art.

The term “include” and its variants as used herein indicate open inclusion, i.e., “including, but not limited to.” Unless specifically stated otherwise, the term “or” indicates “and/or.” The term “based on” indicates “based at least in part on.” The terms “an exemplary implementation” and “an implementation” indicate “at least one exemplary implementation.” The term “another implementation” indicates “at least one additional implementation.” The terms “first,” “second,” and the like may refer to different or identical objects. Other explicit and implicit definitions may also be included below.

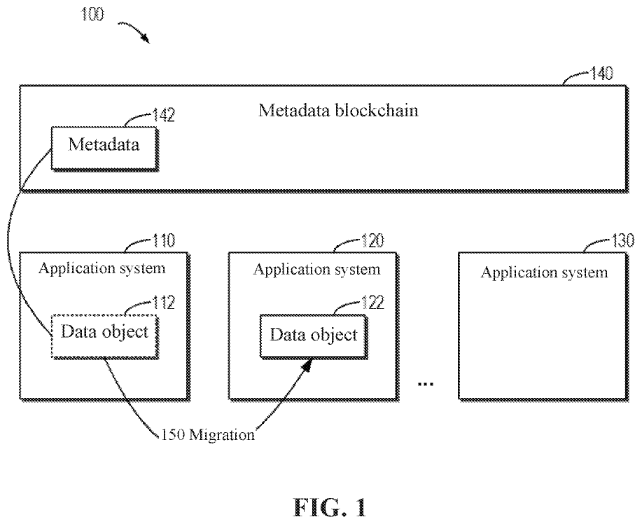

Technical solutions for data protection have long focused on managing data objects more reliably. With the development of the blockchain technology, an immutable blockchain-based technology has been provided to manage data objects so as to provide higher security. FIG. 1 schematically illustrates a block diagram 100 of a process for managing a data object 112 according to a technical solution. As shown in FIG. 1, an application environment may include a plurality of application systems, i.e., an application system 110, an application system 120, . . . , and an application system 130. The application systems here can be configured to provide a variety of services for a user, and each application system may include one or more data objects. For example, the application systems 110 may be configured to provide a music service and include a data object 112. The data object 112 here may be a data block for storing music data.

It will be appreciated that although a music database is used as an example of the data object 112, the data object 112 here may also include other types of data, such as text files, images, audio, video, and other file types. For another example, the data object 112 may also include images of an operating system, an application system, and so on at the application system 110. The data object 112 can be migrated from one application system to another application system for a variety of reasons. At present, a technical solution for preventing hackers or malicious programs from tampering with a data object based on a blockchain technology has been proposed.

A metadata blockchain 140 may be included in the application environment, for storing metadata related to various data objects. The metadata here may include digest information of a data object. For example, digest information 142 of the data object 112 can be generated, and the digest information 142 is stored in the metadata blockchain 140. It will be appreciated that, in the running process of various application systems, the application systems may be vulnerable to hackers, malicious programs, and/or other types of attacks. For example, a malicious program may tamper with content of the data object 112, causing the data object 112 to be inconsistent with original raw data. During data migration 150, metadata can be generated for a migrated data object 122, and the generated metadata is compared with the metadata 142 in the metadata blockchain to see whether they are consistent, thereby ensuring the security of the data object.

It will be appreciated that although FIG. 1 schematically illustrates a data object 112 and a migrated data object 122 thereof, more data objects may exist in an actual application environment. Further, metadata of more data objects may also be included in the metadata blockchain 140. Whether the data object 112 is tampered with during the migration can be validated in the above manner; however, a malicious program or hacker may steal data by performing illegal migration operations. In this case, it is expected that the migration of a data object is managed more securely and reliably to prevent illegal migration operations.

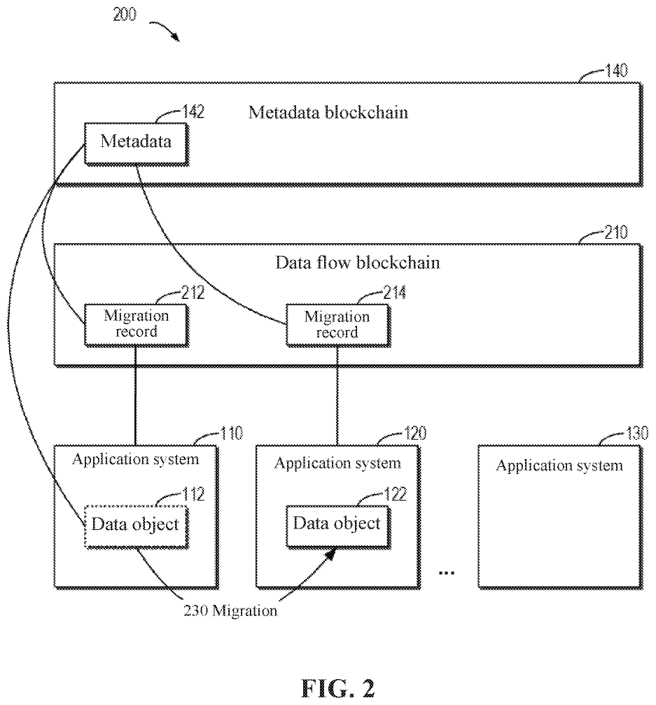

In order to solve the above defects, a method, a device, and a computer program product for managing a data object are provided in implementations of this disclosure. According to exemplary implementations of this disclosure, the concept of a data flow blockchain is proposed, and information related to historical migrations performed for the data object 112 may be stored in the data flow blockchain. The architecture of the implementations of this disclosure will be generally described below with reference to FIG. 2.

FIG. 2 schematically illustrates a block diagram 200 of a process for managing a data object according to an exemplary implementation of this disclosure. As shown in FIG. 2, the data flow blockchain 210 may include a migration record associated with the migration of the data object 112. The migration record 212 may include a variety of information associated with the data object 112. In this case, ownership information associated with the data object 112 may be included in the data flow blockchain 210, and since the data flow blockchain 210 is immutable, malicious programs or hackers can be prevented from illegally tampering with the migration record of the data object 112. Further, it may be validated, based on the migration record, whether a migration request is legal, thereby effectively preventing the data object 112 from being migrated to an illegal destination application system. A corresponding migration record may be generated for each migration operation. For example, a migration record 214 may also be generated as the data object is migrated.

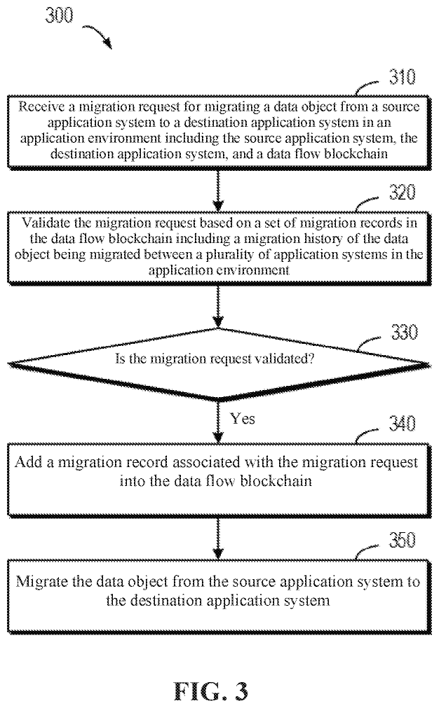

By using the exemplary implementations of the disclosure, a migration record related to a migration operation is recorded based on the data flow blockchain 210, which can improve the security of a data object, thereby reducing the risk of illegal migration. More details of the implementations of this disclosure will be described below with reference to FIG. 3.

FIG. 3 schematically illustrates a flowchart of a method 300 for managing a data object according to an exemplary implementation of this disclosure. As shown in FIG. 3, in block 310, a migration request for migrating the data object from the source application system to the destination application system is received. The migration request here may be triggered based on a variety of conditions. For example, the migration request may be generated based on a shortage of storage space in the source application system, a failure in the source application system, a potential risk in the source application system, and the like.

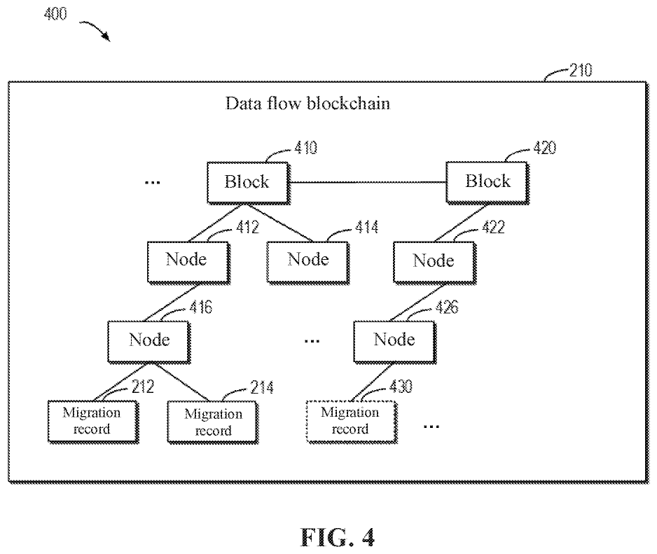

In block 320, the migration request is validated based on a set of migration records in the data flow blockchain 210. The data flow blockchain 210 may include a migration history of the data object 112 being migrated between a plurality of application systems in the application environment. It will be appreciated that the set of migration records here can be linked together as a blockchain and the history of migration of the data object is recorded immutably. A data structure related to the data flow blockchain 210 will be described below with reference to FIG. 4.

FIG. 4 schematically illustrates a structural block diagram 400 of the data flow blockchain 210 according to an exemplary implementation of this disclosure. As shown in FIG. 4, a set of migration records may include a migration record 212, a migration record 214, and the like. A node 416 may be generated based on digests of the migration records 212 and 214, and an upper node can be generated based on information of a lower node. For example, a node 412 is generated based on a child node 416 and other child nodes of the node 412, and a block 410 is generated based on the node 412 and a node 414.

It will be appreciated that although FIG. 4 only schematically illustrates the migration record associated with the data object 112, according to an exemplary implementation of this disclosure, migration records associated with one or more other data objects may also be included in the data flow blockchain 210. In this manner, the data flow blockchain 210 stores migration histories associated with a plurality of data objects immutably. A historical migration that has been performed in the application environment can be accurately determined by searching the data flow blockchain 210 for the migration record associated with the data object 112.

According to an exemplary implementation of this disclosure, the set of migration records includes a previous migration record associated with a previous migration request performed for the data object. Specifically, a corresponding previous migration record can be generated based on each previous migration operation. As shown in FIG. 4, the migration record 212 may correspond to one previous migration operation of the data object 112, while the migration record 214 may correspond to another previous migration operation of the data object 112.

As time goes on, a migration record associated with each migration operation can be continuously inserted into the data flow blockchain 210. For example, a migration record 430 and other migration records can be added. Then, a node 426, a node 422, and a new block 420 can be generated step by step in an order from bottom to top. The block 420 can be linked to the block 410 and used as a part of the data flow blockchain 210.

It will be appreciated that a series of previously performed migration operations are performed in a chronological order, and therefore, for two successive migration operations, a destination application system involved in the former migration operation will be a source application system involved in the latter migration operation system. Thus, according to an exemplary implementation of this disclosure, the previous migration record includes previous source information associated with a source application system involved in the previous migration request, and previous destination information associated with a destination application system involved in the previous migration request. In this case, the destination application system involved in the previous migration request is the same as the source application system. Since the migration records can be linked by hashing as a blockchain, a traceable migration operation history can be further formed based on all migration records for the same metadata.

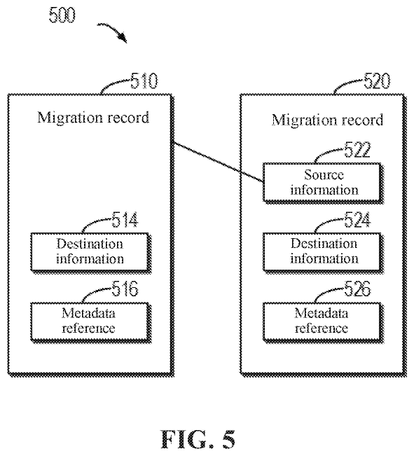

FIG. 5 schematically illustrates a block diagram 500 of a migration record according to an exemplary implementation of this disclosure. FIG. 5 schematically illustrates two successive migration records 510 and 520, which correspond to two migration operations that are performed consecutively in time, respectively. As shown in FIG. 5, each migration record may include: source information for indicating a source application system involved in the migration request; and destination information for indicating a destination application system involved in the migration request. It will be appreciated that a first migration record of the data object may be referred to as a basic migration record, and the migration operation may be initiated by an original owner of the data object. In this particular migration record, the source information can be null.

Further, the migration record may also include a metadata reference, which may be, for example, a pointer that points to a location of the metadata of the data object in the metadata blockchain 140. As shown in FIG. 5, the migration record 510 may include destination information 514 and a metadata reference 516, and the migration record 520 may include source information 522, destination information 524, and a metadata reference 526. In this case, the destination application system in the destination information 514 can be the same as the source application system in the source information 522.

Referring back to FIG. 3, in block 330, it may be determined whether the migration request is validated. According to an exemplary implementation of this disclosure, an ownership of the source application system for the data object may be determined based on the previous migration record. If the source application system has the ownership, it is determined that the migration request is validated. If the source application does not have the ownership, it is determined that the migration request is not validated. By using the exemplary implementation of this disclosure, whether the migration request is legal may be determined based on the ownership in the historical migration record that has been validated as valid. In this case, potential risks in the data migration process can be reduced in a simpler and more efficient manner.

According to an exemplary implementation of this disclosure, ownership information may be determined from previous destination information included in the previous migration record. As already described above, the migration record may include source information, destination information, and a metadata reference. The source information here indicates from which application system the migration history of the data object begins. Further, the source information may also include a hash of the migration record linked to the previous migration record, and a proof of ownership of a migration operation prior to a current migration operation of the data object. The proof of ownership of the previous migration operation can be acquired from the source information of the migration record to validate whether the current migration operation is legal. The destination information in the migration record can indicate which application system the data object is going to. Further, the destination information may also include a proof of ownership after the current migration operation, which may be validated in the next migration operation.

The proof of ownership may be implemented based on an ownership validator of a blockchain, for example, by a script. The proof of ownership may be performed by any node in the application system, and these nodes may be implemented by, for example, a data protection device of a provider of a data protection service. There may be three types of scripts: an ownership script (OwnershipScript), a validation script (ValidationScript) included in the ownership script, and an ownership hash script (OwnershipHashScript). During the migration operation, the source application system places the ownership script in the source information and appends the ownership hash script from the destination information of the previous migration record. The source application system can then place the ownership hash script provided by the destination application system in the destination information. The destination information is used for ownership validation during the next migration operation. An example of scripts for performing ownership validation is schematically illustrated below.

TABLE 1
Example of Scripts

<OwnershipScript> <OwnershipHashScript>
...
OwnershipScript: <signature> <ValidationScript>
...
ValidationScript: <pubkey> [DFOP_VERIFYSIG]
...
OwnershipHashScript: [DFOP_HASH] <ValidationScriptHash>
[DFOP_EQ]

As shown in Table 1, the three types of scripts, OwnershipScript, ValidationScript, and OwnershipHashScript, operate coordinately with each other to achieve the purpose of ownership validation. The <signature> in the script represents a signature for performing encryption, <pubkey> represents a public key for performing decryption, and [DFOP_VERIFYSIG], [DFOP_HASH], and [DFOP_EQ] can represent different actions respectively, such as a validation action, a hash action, and a push action. It will be appreciated that the Table 1 above merely illustrates one example of a process for implementing ownership validation by a script, and the ownership of the application system may also be validated in other manners according to the exemplary implementations of this disclosure.

Referring back to FIG. 3, if the migration request is validated, the method 300 proceeds to block 340 in FIG. 3. If the migration request is not validated, an alert can be provided to an administrator of the application system. In block 340, a migration record associated with the migration request is added into the data flow blockchain 210. In this manner, it can be ensured that information associated with each migration operation is included in the data flow blockchain 210. The newly added migration record can be used to validate whether a migration request is allowed when a migration operation is performed the next time.

According to an exemplary implementation of this disclosure, the migration record may be generated in accordance with the format of the migration record described in FIG. 5. Specifically, source information associated with the source application system and destination information associated with the destination application system can be added into the migration record. Further, a reference to the previous migration record can also be added into the migration record. In this manner, the currently newly generated migration record is linked to the previous migration record. Based on a format in which the records are stored in the blockchain, hash values can also be generated layer by layer to ensure that the content in the data flow blockchain 210 is not tampered with.

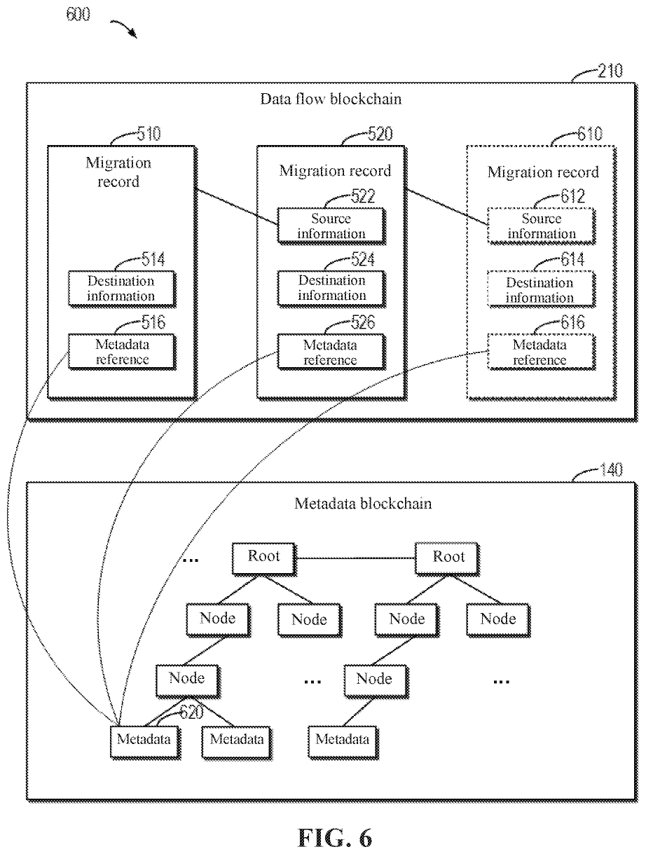

According to an exemplary implementation of this disclosure, a reference to metadata of the data object may be added into the migration record, and here the metadata is stored in a metadata blockchain 140 associated with a set of application systems. With this reference, metadata associated with the migrated data object can be quickly found. How to add a new migration record 610 into the data flow blockchain 210 will be described below with reference to FIG. 6. FIG. 6 schematically illustrates a block diagram 600 of the data flow blockchain 210 and a metadata blockchain 140 according to an exemplary implementation of this disclosure. As shown in FIG. 6, the data flow blockchain 210 may include migration records 510 and 520 before the new migration record 610 is added into the data flow blockchain 210. In this case, a metadata reference 516 in the migration record 510 and a metadata reference 526 in the migration record 520 both point to metadata 620 in the metadata blockchain 140.

Then, the migration record 610 as shown by the dashed box can be added into the data flow blockchain 210. The migration record 610 may include source information 612, destination information 614, and a metadata reference 616. In this case, the migration record 610 can be linked to the last migration record 520 and the metadata reference 616 can be directed to the metadata 620. In the case where the migration record 610 has been added into the data flow blockchain 210, the step shown in block 350 of FIG. 3 may be performed. In block 350 of FIG. 3, the data object can be migrated from the source application system to the destination application system. In this case, a variety of information related to the migration operation has been recorded in the data flow blockchain 210, so that the history of the migration operation will not be tampered with, thereby improving the reliability of the application system.

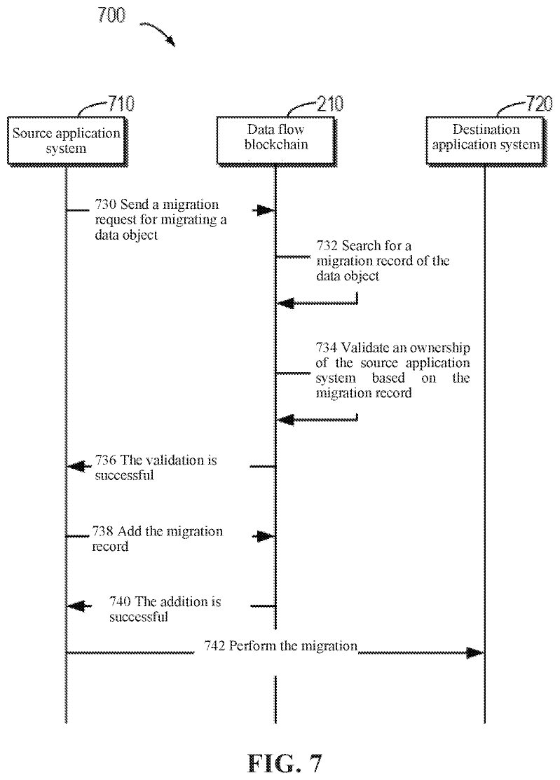

The complete process of migrating the data object from the source application system to the destination application system will be described below with reference to FIG. 7. FIG. 7 schematically illustrates a block diagram 700 of a process for migrating a data object from a source application system to a destination application system according to an exemplary implementation of this disclosure. As shown in FIG. 7, in an initial stage, a data object is stored in a source application system 710, and a destination application system 720 represents a destination of the performed migration operation. As indicated by an arrow 730, the source application system 710 can send to the data flow blockchain 210 a migration request for migrating a data object from the source application system 710 to the destination application system 720.

As indicated by an arrow 732, the data flow blockchain 210 can be searched for a migration record of the data object, and as indicated by an arrow 734, an ownership of the source application system 720 can be validated based on the migration record. If the validation is successful, a message indicating that the validation is successful is returned to the source application system 710, as indicated by an arrow 736. In this case, as indicated by an arrow 738, the source application system 710 can generate a migration record associated with the migration request and add it into the data flow blockchain 210. As indicated by an arrow 740, after the migration record has been added into the data flow blockchain 210, a message indicating successful addition may be returned to the source application system 710. In this case, at an arrow 742, the source application system 710 can perform a migration operation, i.e., the data object can be migrated from the source application system 710 to the destination application system 720. By using the exemplary implementation of this disclosure, the data flow blockchain 210 can ensure that the migration history of the data object is not tampered with, thereby providing a data storage service with higher reliability.

According to an exemplary implementation of this disclosure, in order to further improve the reliability of the migration operation of migrating the data object, it may also be verified, based on the metadata in the metadata blockchain, whether the data object is tampered with. Specifically, the metadata of the data object can be generated based on the data object in the source application system, for comparison with the metadata stored in the metadata blockchain 140. The pre-stored metadata of the data object can be acquired from the metadata blockchain 140 based on the reference in the migration record. It can be determined, based on whether the two pieces of metadata match with each other, whether the data object is changed. If it is determined that the generated metadata matches the acquired metadata, it is confirmed that the data object is not modified, and thus the data object can be migrated from the source application system to the destination application system. If it is determined that the two do not match with each other, an alert can be provided to the administrator of the application system.

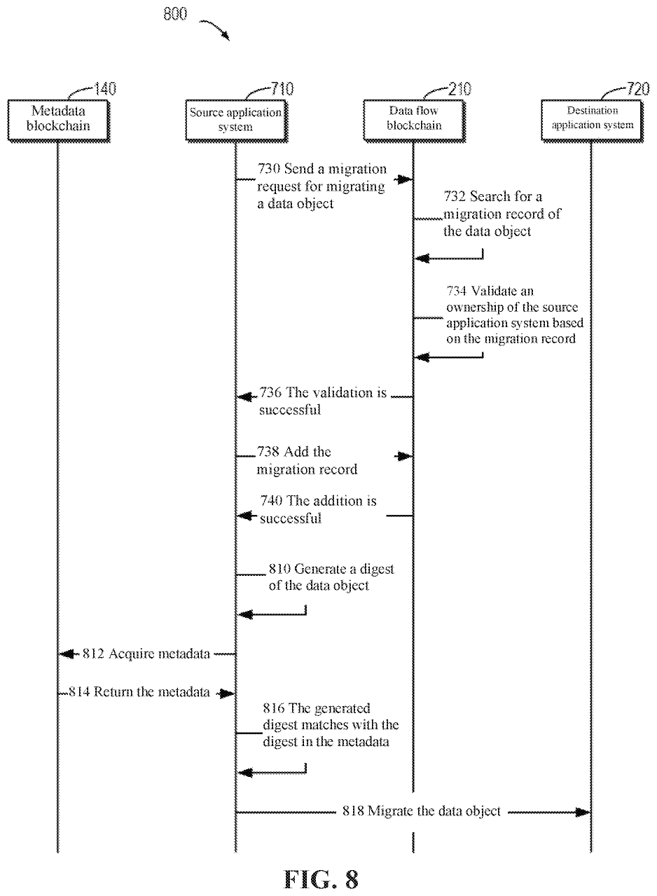

FIG. 8 schematically illustrates a block diagram 800 of a process for migrating a data object from a source application system to a destination application system according to an exemplary implementation of this disclosure. The operations at the arrows 730, 732, 734, 736, 738, and 740 as shown in FIG. 8 are the same as those shown in FIG. 7, and thus will not be described in detail again. FIG. 8 and FIG. 7 have the following differences. FIG. 8 further illustrates a metadata blockchain 140 for storing metadata of the data object, and the process of validating, based on the metadata in the metadata blockchain 140, whether the data object in the source application system 710 is modified is illustrated at arrows 810 to 818 in FIG. 8.

A digest of the data object can be generated at the source application system 710 as indicated by the arrow 810 in FIG. 8. Further, as indicated by the arrow 812, a request for acquiring metadata may be sent to the metadata blockchain 140, and as indicated by the arrow 814, metadata may be returned from the metadata blockchain 140. As indicated by the arrow 816, the generated digest can be compared with the digest in the acquired metadata to determine whether the two match with each other. If the two digests match with each other, the data object can be migrated from the source application system 710 to the destination application system 720 as indicated by the arrow 818.

By using the exemplary implementation of this disclosure, on one hand, based on the data flow blockchain 210, it can be ensured that the source application system and the destination application system in the migration process are application systems with a legal ownership; on the other hand, based on the metadata blockchain 140, it can be validated that the data object in the source application system 710 is not modified. In this manner, the execution of the migration operation can be ensured with higher reliability. It will be appreciated that although FIG. 8 illustrates a process of first validating a migration request based on the data flow blockchain 210 and then validating whether the data object is tampered with based on the metadata blockchain 140, the two validation processes can also be performed in a different order or in parallel according to the exemplary implementations of this disclosure.

According to an exemplary implementation of this disclosure, a history of the data object being copied between various application systems in the application environment may also be determined based on the migration record in the data flow blockchain 210. It will be appreciated that since the content in the data flow blockchain 210 is immutable, historical information about the migration of the data object can be accurately recorded, thereby facilitating the query by the owner of the data object or the administrator of the application system. In this manner, it can be ensured that each migration operation of the data object is traceable, and then more monitoring can be provided for the management of the application system.

Specifically, if a query request for querying the migration history of the data object is received, a set of migration records may be searched for a migration record associated with the query request. For example, a search can be conducted based on an identifier of the data object. It will be appreciated that the migration record may include a reference to the previous migration record, and therefore, a previous migration record may be progressively obtained based on a reference in the found migration request. In this manner, a set of historical migration records associated with the data object can be acquired. For each historical migration record in the obtained set of historical migration records, the migration history of the data object can be determined based on the source application system and the destination application system recorded therein.

According to an exemplary implementation of this disclosure, a white list including trusted application systems may also be provided in the application environment. Specifically, a white list associated with a set of application systems can be acquired, the white list including a list of application systems that are allowed to be used as a destination of the migration operation. If it is determined that the destination application system is included in the white list, the data object can be migrated from the source application system to the destination application system. According to an exemplary implementation of this disclosure, if the migration request is not validated and/or the destination application system is not included in the white list, the migration of the data object from the source application system to the destination application system is prevented. According to an exemplary implementation of this disclosure, a communication interface may be provided between the metadata blockchain 140 and the data flow blockchain 210 to exchange data.

In a conventional application environment that does not include the data flow blockchain 210 and the metadata blockchain 140, the metadata and copy records stored locally in the application system are likely to be tampered with by hackers or malicious programs. According to an exemplary implementation of this disclosure, by using the data flow blockchain 210 and the metadata blockchain 140, all information related to security of the protected data object (e.g., ownership information and metadata information) is stored in the blockchain, and no attacker can modify the information. In this manner, potential risks can be reduced, and data security and traceability can be improved. By using the exemplary implementations of this disclosure, the robustness of the technical solution for data protection can be significantly improved. The data flow blockchain 210 and the metadata blockchain 140 described with reference to the foregoing can be used as the infrastructure of data protection services, and more applications can be developed on the infrastructure. In this manner, the security during a data migration operation can be ensured, and the complexity of the migration process is significantly reduced at the same time.

The example of the method according to this disclosure has been described in detail above with reference to FIG. 2 to FIG. 8, and an implementation of a corresponding apparatus will be described below. In accordance with an exemplary implementation of this disclosure, an apparatus for managing a data object in an application environment is provided. The application environment includes a source application system, a destination application system, and a data flow blockchain. The apparatus includes: a receiving module configured to receive a migration request for migrating the data object from the source application system to the destination application system; a validation module configured to validate the migration request based on a set of migration records in the data flow blockchain including a migration history of the data object being migrated between a plurality of application systems in the application environment; an adding module configured to add a migration record associated with the migration request into the data flow blockchain in response to the validation of the migration request; and a migration module configured to migrate the data object from the source application system to the destination application system.

According to an exemplary implementation of this disclosure, the set of migration records includes a previous migration record associated with a previous migration request executed for the data object; and the previous migration record includes previous source information associated with a source application system involved in the previous migration request and previous destination information associated with a destination application system involved in the previous migration request, and the destination application system involved in the previous migration request is the same as the source application system.

According to an exemplary implementation of this disclosure, the validation module includes: an ownership determination module configured to determine an ownership of the source application system for the data object based on the previous migration record; and the validation module is further configured to, in response to the source application system having the ownership, determine that the migration request is validated; and in response to the source application system not having the ownership, determine that the migration request is not validated.

According to an exemplary implementation of this disclosure, the ownership determination module includes: an acquisition module configured to determine ownership information from the previous destination information included in the previous migration record; and an ownership module configured to validate the ownership of the source application system for the data object based on the ownership information.

According to an exemplary implementation of this disclosure, the adding module is further configured to add source information associated with the source application system, destination information associated with the destination application system, and a reference to the previous migration record into the migration record.

According to an exemplary implementation of this disclosure, the application environment further includes a metadata blockchain, and the apparatus further includes a metadata module configured to add a reference to metadata of the data object into the migration record, the metadata being stored in the metadata blockchain.

According to an exemplary implementation of this disclosure, the apparatus further includes: a generation module configured to generate the metadata of the data object based on the data object in the source application system; a metadata acquisition module configured to acquire the metadata of the data object from the metadata blockchain based on the reference in the migration record; and the migration module is further configured to migrate the data object from the source application system to the destination application system in response to a determination that the generated metadata matches the acquired metadata.

According to an exemplary implementation of this disclosure, the apparatus further includes: a query module configured to receive a query request for querying the migration history of the data object; a search module configured to search the set of migration records for a migration record associated with the query request; a record acquisition module configured to acquire, based on the reference to the previous migration record included in the migration record, a set of historical migration records associated with the data object; and a history acquisition module configured to acquire the migration history based on a corresponding source application system and a corresponding destination application system in a corresponding historical migration record in the set of historical migration records.

According to an exemplary implementation of this disclosure, the migration module further includes: a white list module configured to acquire a white list associated with the application environment, the while list including a list of application systems that are allowed to be used as a destination of the migration operation; and the migration module is further configured to migrate the data object from the source application system to the destination application system in response to a determination that the destination application system is included in the while list.

According to an exemplary implementation of this disclosure, the apparatus further includes a preventing module configured to prevent the migration of the data object from the source application system to the destination application system in response to non-validation of the migration request.

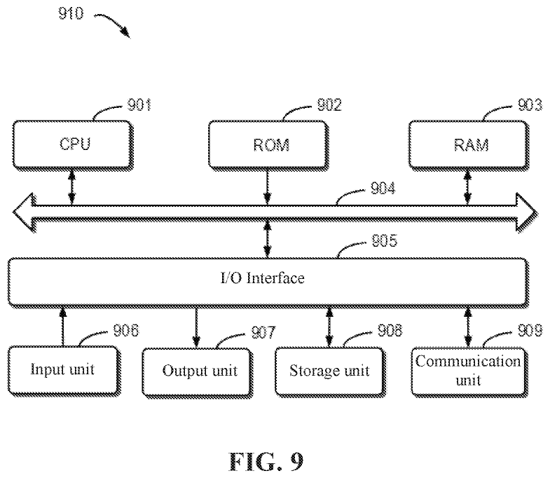

FIG. 9 schematically illustrates a block diagram of a device 900 for managing a data object according to an exemplary implementation of this disclosure. As shown in the figure, the device 900 includes a central processing unit (CPU) 901 that can perform various appropriate actions and processing according to computer program instructions stored in a read-only memory (ROM) 902 or computer program instructions loaded from a storage unit 908 to a random access memory (RAM) 903. In the RAM 903, various programs and data required for the operation of the device 900 can also be stored. The CPU 901, the ROM 902, and the RAM 903 are connected to each other through a bus 904. An input/output (I/O) interface 905 is also coupled to the bus 904.

A plurality of components in the device 900 are connected to the I/O interface 905, including: an input unit 906, such as a keyboard and a mouse; an output unit 907, such as various types of displays and speakers; a storage unit 908, such as a magnetic disk and an optical disc; and a communication unit 909, such as a network card, a modem, and a wireless communication transceiver. The communication unit 909 allows the device 900 to exchange information/data with other devices over a computer network such as the Internet and/or various telecommunication networks.

The various processes and processing described above, for example, the method 300, may be performed by the processing unit 901. For example, in some implementations, the method 300 can be implemented as a computer software program tangibly included in a machine readable medium, such as the storage unit 908. In some implementations, some or all of the computer program can be loaded and/or installed onto the device 900 via the ROM 902 and/or the communication unit 909. When the computer program is loaded into the RAM 903 and executed by the CPU 901, one or more of the steps of the method 300 described above may be implemented. Alternatively, in other implementations, the CPU 901 can also be configured in any other suitable manner to implement the processes/methods described above.

According to an exemplary implementation of this disclosure, a device for managing a data object in an application environment is provided. The application environment includes a source application system, a destination application system, and a data flow blockchain. The device includes: at least one processing unit; and at least one memory coupled to the at least one processing unit and storing instructions for execution by the at least one processing unit, wherein when executed by the at least one processing unit, the instructions cause the apparatus to perform actions. The actions include: receiving a migration request for migrating the data object from the source application system to the destination application system; validating the migration request based on a set of migration records in the data flow blockchain including a migration history of the data object being migrated between a plurality of application systems in the application environment; adding a migration record associated with the migration request into the data flow blockchain in response to the validation of the migration request; and migrating the data object from the source application system to the destination application system.

According to an exemplary implementation of this disclosure, the set of migration records includes a previous migration record associated with a previous migration request executed for the data object; and the previous migration record includes previous source information associated with a source application system involved in the previous migration request and previous destination information associated with a destination application system involved in the previous migration request, and the destination application system involved in the previous migration request is the same as the source application system.

According to an exemplary implementation of this disclosure, the validating the migration request includes: determining an ownership of the source application system for the data object based on the previous migration record; in response to the source application system having the ownership, determining that the migration request is validated; and in response to the source application system not having the ownership, determining that the migration request is not validated.

According to an exemplary implementation of this disclosure, the determining an ownership of the source application system for the data object includes: determining ownership information from the previous destination information included in the previous migration record; and validating the ownership of the source application system for the data object based on the ownership information.

According to an exemplary implementation of this disclosure, the adding a migration record associated with the migration request into the data flow blockchain includes: adding source information associated with the source application system, destination information associated with the destination application system, and a reference to the previous migration record into the migration record.

According to an exemplary implementation of this disclosure, the application environment further includes a metadata blockchain, and the actions further include: adding a reference to metadata of the data object into the migration record, the metadata being stored in the metadata blockchain.

According to an exemplary implementation of this disclosure, the actions further include: generating the metadata of the data object based on the data object in the source application system; acquiring the metadata of the data object from the metadata blockchain based on the reference in the migration record; and migrating the data object from the source application system to the destination application system in response to a determination that the generated metadata matches the acquired metadata.

According to an exemplary implementation of this disclosure, the actions further include: receiving a query request for querying the migration history of the data object; searching the set of migration records for a migration record associated with the query request; acquiring, based on the reference to the previous migration record included in the migration record, a set of historical migration records associated with the data object; and acquiring the migration history based on a corresponding source application system and a corresponding destination application system in a corresponding historical migration record in the set of historical migration records.

According to an exemplary implementation of this disclosure, the migrating the data object from the source application system to the destination application system includes: acquiring a white list associated with the application environment, the while list including a list of application systems that are allowed to be used as a destination of the migration operation; and migrating the data object from the source application system to the destination application system in response to a determination that the destination application system is included in the while list.

According to an exemplary implementation of this disclosure, the actions further include: preventing the migration of the data object from the source application system to the destination application system in response to non-validation of the migration request.

According to an exemplary implementation of this disclosure, a computer program product is provided. The computer program product is tangibly stored in a non-transitory computer readable medium and includes machine executable instructions for performing the method according to this disclosure.

According to an exemplary implementation of this disclosure, a computer readable medium is provided. Machine executable instructions are stored on the computer readable medium, and when executed by at least one processor, the machine executable instructions cause the at least one processor to implement the method according to this disclosure.

This disclosure may be a method, a device, a system, and/or a computer program product. The computer program product may include a computer readable storage medium storing computer readable program instructions for performing various aspects of this disclosure.

The computer readable storage medium can be a physical device capable of retaining and storing instructions used by an instruction executing device. The computer readable storage medium can be, for example, but is not limited to, an electrical storage device, a magnetic storage device, an optical storage device, an electromagnetic storage device, a semiconductor storage device, or a combination of any of the above. More specific examples (a non-exhaustive list) of the computer readable storage medium include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical coding device such as a punched card or protrusions in a groove on which instructions are stored, and any appropriate combination of the above. The computer readable storage medium as used herein is not explained as an instant signal itself, such as radio waves or other electromagnetic waves propagated freely, electromagnetic waves propagated through waveguides or other transmission media (e.g., light pulses propagated through fiber-optic cables), or electrical signals transmitted over wires.

The computer readable program instructions described here may be downloaded from the computer readable storage medium to various computing/processing devices or downloaded to external computers or external storage devices over a network such as the Internet, a local area network, a wide area network and/or a wireless network. The network may include copper transmission cables, fiber optic transmission, wireless transmission, routers, firewalls, switches, gateway computers and/or edge servers. A network adapter card or network interface in each computing/processing device receives computer readable program instructions from the network and forwards the computer readable program instructions for storage in the computer readable storage medium in each computing/processing device.

The computer program instructions for performing the operations of this disclosure may be assembly instructions, instruction set architecture (ISA) instructions, machine instructions, machine-related instructions, microcode, firmware instructions, state setting data, or source code or object code written in any combination of one or more programming languages, including object oriented programming languages such as Smalltalk and C++ as well as conventional procedural programming languages such as the “C” language or similar programming languages. The computer readable program instructions may be executed completely on a user's computer, partially on the user's computer, as a separate software package, partially on the user's computer and partially on a remote computer, or completely on the remote computer or server. In the case where a remote computer is involved, the remote computer can be connected to a user computer over any kind of network, including a local area network (LAN) or wide area network (WAN), or can be connected to an external computer (e.g., connected over the Internet using an Internet service provider). In some implementations, an electronic circuit, such as a programmable logic circuit, a field programmable gate array (FPGA), or a programmable logic array (PLA), can be customized by utilizing state information of the computer readable program instructions. The computer readable program instructions are executable by the electronic circuit to implement various aspects of this disclosure.

Various aspects of this disclosure are described here with reference to flowcharts and/or block diagrams of the method, the apparatus (system) and the computer program products implemented according to this disclosure. It should be understood that a computer program instruction may be used to implement each block in the flowcharts and/or block diagrams and a combination of blocks in the flowcharts and/or block diagrams.

The computer readable program instructions can be provided to a processing unit of a general purpose computer, a special purpose computer or another programmable data processing apparatus to produce a machine such that the instructions, when executed by the processing unit of the computer or another programmable data processing apparatus, generate an apparatus for implementing the functions/actions specified in one or more blocks in the flowchart and/or block diagrams. The computer program instructions may also be stored in a computer readable memory that can guide the computer or another programmable data processing apparatus and/or other devices to work in a specific manner, such that the computer readable medium storing the instructions includes a manufacture including instructions for implementing various aspects of functions/actions specified by one or more blocks in the flowcharts and/or block diagrams.

The computer readable program instructions may also be loaded onto a computer, another programmable data processing apparatus, or another device such that a series of operational steps are performed on the computer, another programmable data processing apparatus or another device to produce a computer implemented process. As such, the instructions executed on the computer, another programmable data processing apparatus, or another device implement the functions/actions specified in one or more blocks in the flowcharts and/or block diagrams.

The flowcharts and block diagrams in the accompanying drawings illustrate the architecture, functions, and operations of possible implementations of devices, methods, and computer program products according to multiple embodiments of this disclosure. In this regard, each block in the flowcharts or block diagrams can represent a module, a program segment, or a portion of an instruction that includes one or more executable instructions for implementing the specified logical functions. In some alternative implementations, functions labeled in the blocks may occur in an order different from that as labeled in the accompanying drawing. For example, two successive blocks may actually be performed basically in parallel, or they can be performed in an opposite order sometimes, depending on involved functions. It also should be noted that each block in the block diagrams and/or flowcharts, and a combination of blocks in the block diagrams and/or flowcharts can be implemented using a dedicated hardware-based system for executing specified functions or actions, or can be implemented using a combination of dedicated hardware and computer instructions.

The implementations of this disclosure have been described above, and the foregoing description is illustrative rather than exhaustive, and is not limited to the disclosed implementations. Numerous modifications and changes are apparent to those of ordinary skill in the art without departing from the scope and spirit of various illustrated implementations. The selection of terms as used herein is intended to best explain the principles and practical applications of the various implementations, or technical improvements of the technologies on the market, or to enable other persons of ordinary skill in the art to understand the implementations disclosed here.

1. A method for managing a data object, the method comprising:
receiving a migration request for migrating the data object from a source application system to a destination application system;
validating the migration request based on a set of migration records in a data flow blockchain comprising a migration history of the data object being migrated between a plurality of application systems;
adding a migration record associated with the migration request into the data flow blockchain in response to the validation of the migration request; and
migrating the data object from the source application system to the destination application system.

2. The method of claim 1, wherein
the set of migration records comprises a previous migration record associated with a previous migration request executed for the data object;
the previous migration record comprises previous source information associated the previous migration request and previous destination information associated with in the previous migration request; and
the previous destination information specifies the source application system.

3. The method of claim 2, wherein the validating the migration request comprises:
determining that the source application system is an owner of the data object based on the previous migration record;
in response to the source application system being the owner, determining that the migration request is validated; and
in response to the source application system not being the owner, determining that the migration request is not validated.

4. The method of claim 3, wherein the determining that the source application system is the owner of the data object comprises:
determining ownership information from the previous destination information comprised in the previous migration record; and
validating that the source application system is the owner of the data object based on the ownership information.

5. The method of claim 2, wherein the adding the migration record associated with the migration request into the data flow blockchain comprises:
adding source information associated with the source application system, destination information associated with the destination application system, and a reference to the previous migration record into the migration record.

6. The method of claim 5, further comprising:
adding a reference to metadata of the data object into the migration record, the metadata being stored in a metadata blockchain.

7. The method of claim 6, further comprising:
generating the metadata of the data object based on the data object in the source application system;
acquiring the metadata of the data object from the metadata blockchain based on the reference to metadata in the migration record; and
wherein migrating the data object from the source application system to the destination application system is only performed in response to a determination that the generated metadata matches the acquired metadata.

8. The method of claim 5, further comprising:
receiving a query request for querying the migration history of the data object;
searching the set of migration records for the migration record, wherein the migration record is associated with the query request;
acquiring a set of historical migration records associated with the data object based on the reference to the previous migration record in the migration record; and
acquiring the migration history based on a corresponding source application system and a corresponding destination application system in a corresponding historical migration record in the set of historical migration records.

9. The method of claim 1, wherein the migrating the data object from the source application system to the destination application system comprises:
acquiring a white list, the white list comprising a list of application systems that are allowed to be used as a destination of the migration; and
migrating the data object from the source application system to the destination application system in response to a determination that the destination application system is specified in the white list.

10. The method of claim 1, further comprising:
preventing the migration of the data object from the source application system to the destination application system in response to non-validation of the migration request.

11. A device for managing a data object, the device comprising:
at least one processing unit; and
at least one memory coupled to the at least one processing unit and storing instructions for execution by the at least one processing unit, wherein when executed by the at least one processing unit, the instructions cause the at least one processing unit to perform actions comprising:
receiving a migration request for migrating the data object from a source application system to a destination application system;
validating the migration request based on a set of migration records in a data flow blockchain comprising a migration history of the data object being migrated between a plurality of application systems;
adding a migration record associated with the migration request into the data flow blockchain in response to the validation of the migration request; and
migrating the data object from the source application system to the destination application system.

12. The device of claim 11, wherein
the set of migration records comprises a previous migration record associated with a previous migration request executed for the data object;
the previous migration record comprises previous source information associated the previous migration request and previous destination information associated with in the previous migration request; and
the previous destination information specifies the source application system.

13. The device of claim 12, wherein the validating the migration request comprises:
determining that the source application system is an owner of the data object based on the previous migration record;
in response to the source application system being the owner, determining that the migration request is validated; and
in response to the source application system not being the owner, determining that the migration request is not validated.

14. The device of claim 13, wherein the determining that the source application system is the owner of the data object comprises:
determining ownership information from the previous destination information comprised in the previous migration record; and
validating that the source application system is the owner of the data object based on the ownership information

15. The device of claim 12, wherein the adding the migration record associated with the migration request into the data flow blockchain comprises:
adding source information associated with the source application system, destination information associated with the destination application system, and a reference to the previous migration record into the migration record.

16. The device of claim 15, further comprising:
adding a reference to metadata of the data object into the migration record, the metadata being stored in a metadata blockchain

17. The device of claim 16, wherein the actions further comprise:
generating the metadata of the data object based on the data object in the source application system;
acquiring the metadata of the data object from the metadata blockchain based on the reference to metadata in the migration record; and
wherein migrating the data object from the source application system to the destination application system is only performed in response to a determination that the generated metadata matches the acquired metadata.

18. The device of claim 15, wherein the actions further comprise:
receiving a query request for querying the migration history of the data object;
searching the set of migration records for the migration record, wherein the migration record is associated with the query request;
acquiring a set of historical migration records associated with the data object based on the reference to the previous migration record comprised in the migration record; and
acquiring the migration history based on a corresponding source application system and a corresponding destination application system in a corresponding historical migration record in the set of historical migration records.

19. The device of claim 11, wherein the migrating the data object from the source application system to the destination application system comprises:
acquiring a white list, the white list comprising a list of application systems that are allowed to be used as a destination of the migration; and
migrating the data object from the source application system to the destination application system in response to a determination that the destination application system is specified in the white list.

20. A computer program product tangibly stored in a non-transitory computer storage medium and comprising machine executable instructions, wherein when executed by a device, the machine executable instructions cause the device to perform a method, the method comprising:
receiving a migration request for migrating the data object from a source application system to a destination application system;
validating the migration request based on a set of migration records in a data flow blockchain comprising a migration history of the data object being migrated between a plurality of application systems;
adding a migration record associated with the migration request into the data flow blockchain in response to the validation of the migration request; and
migrating the data object from the source application system to the destination application system.
